(19) United States
(12) Patent Application Publication
(10) Pub. No.: US 2026/0370668 A1
(43) Pub. Date: Nov. 19, 2026

(54) MASS DETECTION OF MALWARE FROM MULTI-PLATFORM BACKUP AND NETWORK ATTACHED STORAGE ENVIRONMENTS

(71) Applicant: International Business Machine Corporation, Armonk, NY (US)

(72) Inventors: Fraser Iain MacIntosh, Reading (GB); Christopher J. Vollmar, Mississauga (CA)

(21) Appl. No.: 19/207,181

(22) Filed: May 13, 2025

(51) Int. Cl. H04L 9/40; G06F 3/06; G06F 11/1446; G06F 16/174; G06F 21/56

(52) U.S. Cl. CPC H04L 63/1425; G06F 11/1464; G06F 16/1748; G06F 21/56; H04L 63/1416; H04L 63/1441; G06F 3/0608; G06F 11/1453; G06F 16/1752

(57) ABSTRACT

A method, according to one approach, includes: identifying a suspect file and copying the suspect file to a detection service. An algorithm catalog is checked for one or more target platforms. In response to identifying one or more target platforms in the algorithm catalog, the target platforms are selected for inspection. Moreover, in response to determining that the target platforms share their respective algorithms: the suspect file is deduplicated based at least in part on the algorithms that correspond to the selected target platforms. An outline of blocks is also created based on the respective algorithms that correspond to the selected target platforms. The blocks are compared against each target system deduplication table. Furthermore, in response to determining that none of the blocks are matching, the blocks are compared against a target system deref table.

### BACKGROUND

The present invention relates to malware, and more specifically, this invention relates to detecting malware in systems.

The prevalence of computer systems has increased with the advancement of the Internet, and wireless network standards such as Bluetooth and Wi-Fi. Additionally, the adoption and development of smart devices, e.g., such as smartphones, televisions, tablets, and other devices in the Internet of Things (IoT) has increased as processing power and functionality improve. Moreover, an increasing amount of physical material has been digitized. While this digital conversion improves data storage and data accessibility, it also increases the importance of maintaining cybersecurity (e.g., computer security).

While some platforms have been developed to protect computer systems and networks from such attacks, threats are consistently evolving. Computer systems and networks thereby face various types of attacks over time. Malware is one such type of cybersecurity attack that has been difficult for conventional products to detect and overcome. For instance, malware file sizes have been increasing in recent years and are no longer a few hundred bytes. Often code for malware is distributed in plain text or obfuscated text formats or as fully compiled executables. Accordingly, there exists a need to develop an intelligent system that is able to efficiently recover from ransomware activity.

### SUMMARY

A method, according to one approach, includes: identifying a suspect file and copying the suspect file to a detection service. An algorithm catalog is checked for one or more target platforms. In response to identifying one or more target platforms in the algorithm catalog, the target platforms are selected for inspection. Moreover, in response to determining that the target platforms share their respective algorithms: the suspect file is deduplicated based at least in part on the algorithms that correspond to the selected target platforms. An outline of blocks is also created based on the respective algorithms that correspond to the selected target platforms. The blocks are compared against each target system deduplication table. Furthermore, in response to determining that none of the blocks are matching, the blocks are compared against a target system deref table.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a flowchart of a method, in accordance with one approach.

FIG. 2B is a flowchart of another method, in accordance with one approach.

FIG. 3A is a flowchart of another method, in accordance with one approach.

FIG. 3B is a flowchart of another method, in accordance with one approach.

FIG. 4 is a flowchart of another method, in accordance with one approach.

FIG. 5 is a representational view of a distributed system, in accordance with one approach.

FIG. 6 is a flowchart of another method, in accordance with one approach.

FIG. 7 is a representational overview of malware impacting a source file, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for rapid and mass detection of malware from various systems. Approaches herein may thereby be performed in order to protect multi-platform backup and network attached storage (NAS) environments from malicious attacks, e.g., as will be described in further detail below.

In one general approach, a method includes: identifying a suspect file and copying the suspect file to a detection service. An algorithm catalog is checked for one or more target platforms. In response to identifying one or more target platforms in the algorithm catalog, the target platforms are selected for inspection. Moreover, in response to determining that the target platforms share their respective algorithms: the suspect file is deduplicated based at least in part on the algorithms that correspond to the selected target platforms. An outline of blocks is also created based on the respective algorithms that correspond to the selected target platforms. The blocks are compared against each target system deduplication table. Furthermore, in response to determining that none of the blocks are matching, the blocks are compared against a target system deref table.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved malware detection code in block 150 for rapid and mass detection of malware from various systems. Approaches herein may thereby be performed in order to protect multi-platform backup and NAS environments from malicious attacks, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

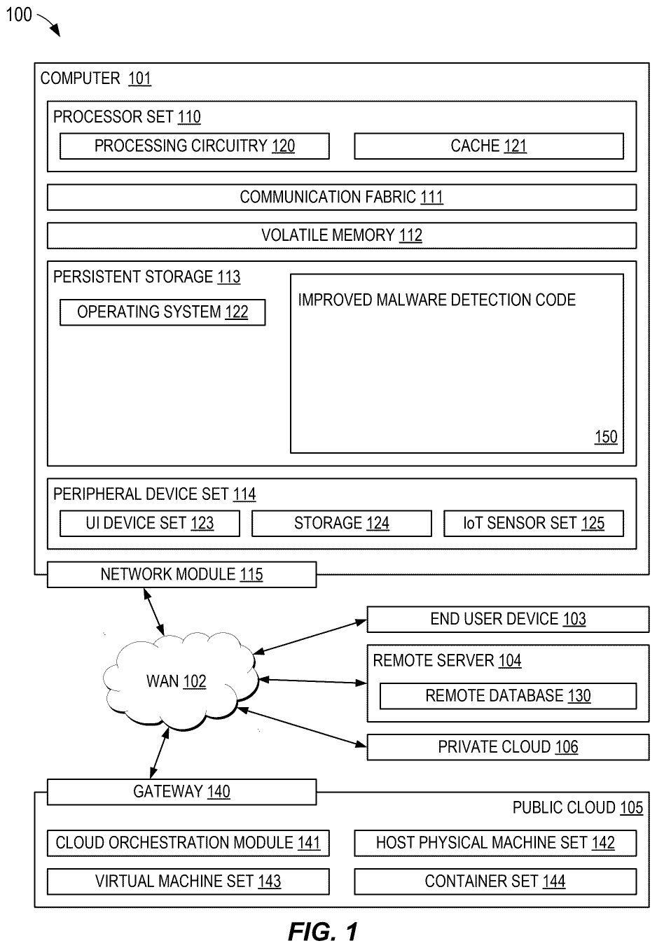

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By “integrated with,” what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, the prevalence of computer systems has increased with the advancement of the Internet, and wireless network standards such as Bluetooth and Wi-Fi. Additionally, the adoption and development of smart devices, e.g., such as smartphones, televisions, tablets, and other devices in the IoT has increased as processing power and functionality improve.

As the importance of computer systems and networks continue to increase, cybersecurity attacks pose an increasingly significant threat. Cybersecurity has thereby become a significant challenge due to the complexity of computer systems in general, as well as the broad application of computer networks. Malware is one such type of cybersecurity attack that has been difficult for conventional products to detect and overcome.

For instance, it has proven to be quite difficult for conventional products to even identify dormant malware that have infected heterogeneous file storage environments, e.g., such as backup storage, hardware security modules (HSMs), WAN accelerators, file transfer gateways, etc. These file storage environments rely heavily on a variety of different deduplication algorithms from different vendors, as well as technology for capacity reduction and savings. It is therefore particularly difficult to identify malware in situations where it exists (e.g., hides) in different files and/or changes names as it moves from server to server. To make matters worse, conventional accelerators and storage systems rely heavily on deduplication technologies.

Detecting malware has also become more difficult over time as the amount of data stored in a system continues to increase. For instance, as the number of volumes stored in memory continues to rise into the tens of thousands, the compute overhead associated with simply inspecting memory for malware has also increased to an unstainable level. Attempts have been made to implement conventional deduplication procedures in order to reduce the physical storage associated with representing data being stored. However, this information varies by vendor, platform, and implementation technique. Accordingly, there exists a need to develop an intelligent system that is able to detect malware activity in an efficient manner.

In sharp contrast to these conventional shortcomings, approaches herein are able to detect malware that is present in storage systems even when it is dormant. This desirably provides a way for clients with multiple different deduplication techniques (e.g., which may correspond to different vendors) to search for dormant malware using the deduplication (e.g. hash tables) and normalize them across platforms. This further enables an agnostic path for multiple vendors to ‘plug-in’, and provide an entity (e.g., organization) the ability to leverage search inside the hash tables of the platform, e.g., as will be described in further detail below.

While in no way intended to be limiting, some approaches may even generate assessments of any identified potential malware that can be used to direct corrective actions performed to remove any verified malware from the system. In other words, some approaches herein may develop an understanding of identified potential malware that may impact the settings (e.g., cybersecurity) of a system, and use that understanding to efficiently respond when malware is actually identified and thereby restore secure operation in the system. Trained machine learning models may even be used to develop an understanding of any events that contributed to identified malware.

Secondary storage systems, such as backup and archive, have the option to store data in a deduplicated format. Deduplication of data is also a common technique for WAN acceleration and other use cases. In addition, it is also increasingly common for primary storage systems to offer data deduplication options. In deduplication systems, various methods are used to reduce the physical storage involved with representing data which are being stored or transmitted. Typically, this is a method to identify non-unique blocks of data and give them a universally unique identification (such as a computed hash value) which enables data built from previously encountered blocks to be represented using just references to the blocks which have been previously stored from a database engine.

The practical upshot is that individual chunks of deduplicated data which are written to a storage system can represent elements of multiple different files or data streams from multiple different clients. Similarly, in network acceleration (such as WAN Acceleration) this can represent data which has come from multiple network nodes. In the case of primary storage, the deduplicated data are potentially representative of multiple client filesystems. In secondary storage environments (such as but not limited to backup, data protection, and archive systems), it is common to use the data stored for various non-production functions, such as analytics, testing, off-line processing, etc. One of the features that has become more common is cyber-resilience and vulnerability detection. That is the ability to use the stored data to observe tell-tale signs of risk, typically malware, malicious attack, etc. Malware file sizes have also been increasing in recent years and are no longer a few hundred bytes. Often code for malware is distributed in plain text or obfuscated text formats or as fully compiled executables.

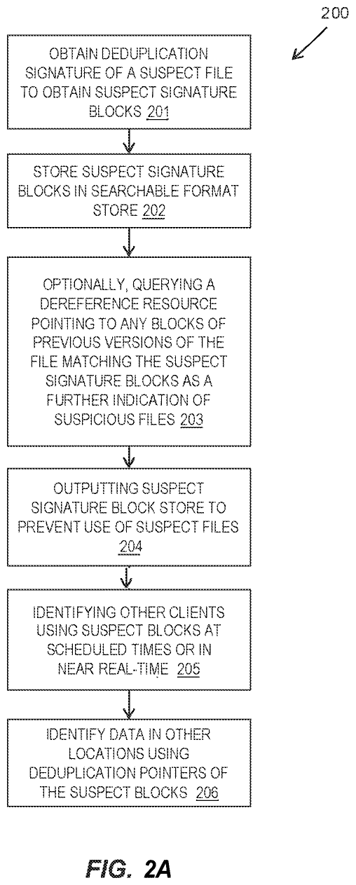

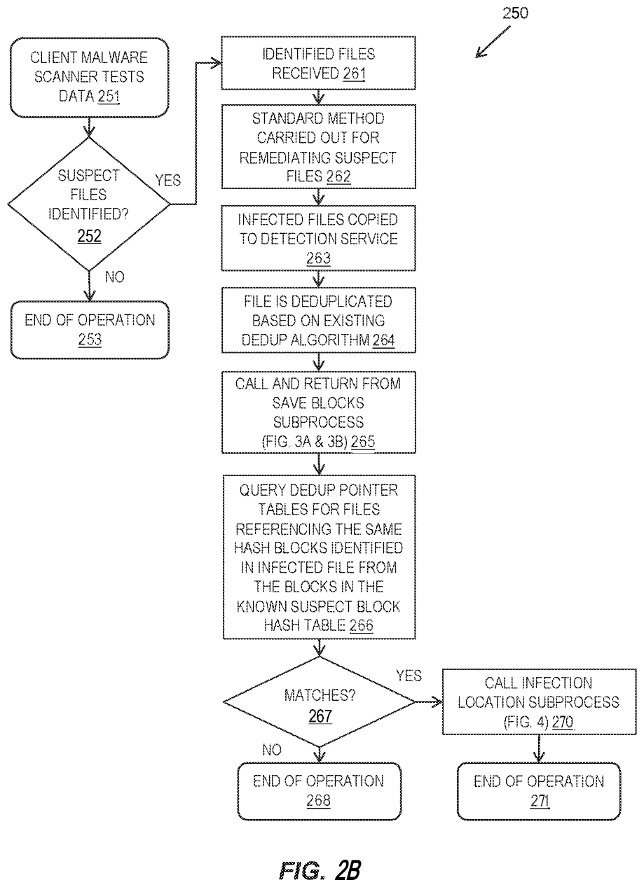

Referring to FIG. 2A, a flow diagram of a method 200 shows an example approach of a computer-implemented method for detection of malware. One or more of the operations in method 200 may thereby be performed in order to protect multi-platform backup and NAS environments from malicious attacks. Accordingly, the method 200 may be performed in accordance with any of the approaches included herein, in various approaches. Of course, more or less operations than those specifically described in FIG. 2A may be included in method 200, as would be understood by one of skill in the art upon reading the present descriptions.

The method may obtain at operation 201 a deduplication signature of a file identified as being suspicious to obtain multiple suspect signature blocks. A signature may be a hash or other form of unique identification of the data used in deduplication. Deduplication patterns are provided by the multiple suspect signature blocks that can be identified in a system in order to identify other instances of potentially suspect data.

The method may store at operation 202 the suspect signature blocks in a searchable format store. In the example approach, this is called a “known suspect block hash table”. Optionally, the method may query at operation 203 a dereference resource, such as a “dereferenced hashes table” or “deref table”, to find any previous versions of files or data referencing the suspect signature blocks. Dereference resources are provided to store information about blocks of data that are no longer current. A comparison of current suspect signature blocks with previous versions may be used as an optional method of identifying code that is changing giving further indication that it is suspicious. For example, code that is morphing, self-encrypting, or concealing will change over time. Code that is changing, or self-encrypting can identify itself by replacing the same parts of a file, meaning that references associated with creating a file are removed, even though it is replacing them with unique blocks.

The dereference resource stores information about blocks which are no longer required to construct the current version of a file. If a file has been identified with malware, the file is compared to how it deduplicated previously. Some blocks will be different, the blocks that are no longer needed to represent the malware infected version of the file will have their hashes stored in the deref table as these are the hashes that may indicate the presence of malware in other files or systems. Alternatively, the known suspect block hash table may include an index of previous versions that can be searched against. In other approaches, the method may be used without the dereference resource to identify malware. This may be used to identify possible locations of suspicious blocks of data without the further test for morphing code. Other additional tests may be carried out on the identified suspicious blocks.

The method may output at operation 204 the suspect signature block store for reference to prevent use of suspicious data blocks. Access may also be provided to the dereference resource. The method may identify at operation 205 other clients using the suspect blocks at scheduled times or in near real-time. This may use different methods for identifying static code and identifying morphing code. This may query deduplication pointer tables to identify 206 the files referencing the suspect signature blocks.

Identifying use of suspect blocks for static code may be performed by a database query to determine if the signatures in the suspect signature store are referenced by other clients' data, for example, stored by a backup server. Identifying use of suspect blocks for morphing code in a storage environment may include the following operations. The dereference table is used to create a list of dereferenced signatures with a list of associated still-referenced signatures for the same file. The deduplication database is used to make a list of clients where all or a statistically significant number of the still referenced signatures exist in the current version. If the clients in this list have the dereferenced signatures still referenced the same number of times as the still referenced signatures within configurable tolerance (i.e., responsive to determining that clients in this last have the dereferenced signatures still referenced the same number of times as the still referenced signatures within configurable tolerance), these clients are removed from the list as likely not infected.

Testing may also be carried out of the blocks which have replaced the dereferenced blocks to test for encryption. Tests for encryption may use methods such as randomness tests, chi squared analysis, Shannon entropy, etc., giving higher confidence that they are infected with polymorphic code. In approaches of storage environments, preventing use may identify suspect signature blocks existing inside files and servers in their different storage copies over time before restoring them. The method may obtain signatures that represent the blocks of previously backed up version of the file from the backup server's database; and may compare these to the stored signatures, allowing dereferenced signatures to be stored in a dereferenced table alongside the still referenced signatures.

In approaches in which the method 200 is implemented in non-storage environments, this may allow blocking endpoints which have indications of suspect code present. Moreover, in approaches of data protection, the method 200 may be implemented by integrating into a data protection environment via access to the suspect signature store hosted in a common database.

Referring now to FIG. 2B, a flow diagram of a method 250 shows an example approach of an aspect of the described method. The example approach is described in the context of a backup storage environment. For example, the method may be performed by one or more components of a malware detection system code discussed in greater detail below. One or more of the operations in method 250 may thereby be performed in order to protect multi-platform backup and NAS environments from malicious attacks. Accordingly, the method 250 may be performed in accordance with any of the approaches included herein, in various approaches. Of course, more or less operations than those specifically described in FIG. 2B may be included in method 250, as would be understood by one of skill in the art upon reading the present descriptions.

An existing security system may be used in operation 251, such as a client malware scanner to test data. It may be determined in operation 252 whether suspicious files are identified. If there are no suspicious files that are identified, the method may end at operation 253 until the next scan. If there are suspect files identified, the method proceeds to receiving the identified files at operation 261. At a high level the data protection server operates as normal, until a file which is infected is encountered. Infected files are identified to the backup client software by an identification method. The identification method may be, as examples, a malware scanner, other security software, or manually by the organization's security team. Standard methods may be carried out at operation 262 for remediating the identified suspect files. It should be noted that during nominal operation, if an infected file is identified, it can be passed to the backup server by various methods automatic and manual which are not limited to the backup process details provided above.

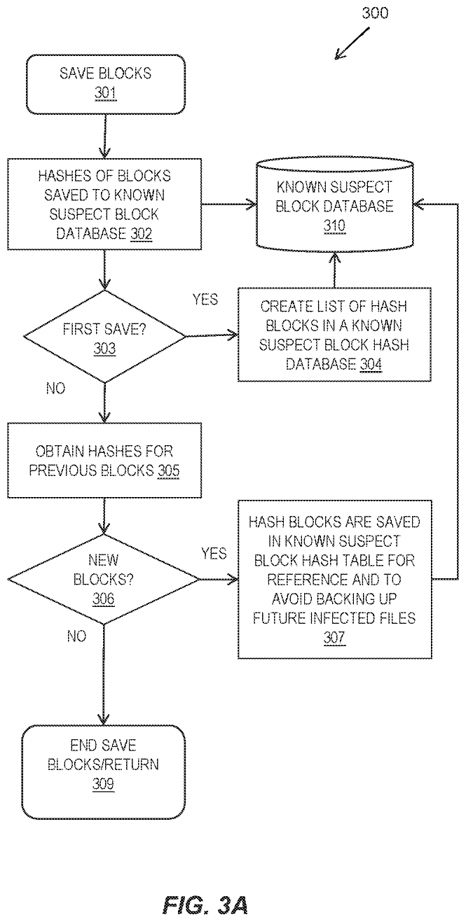

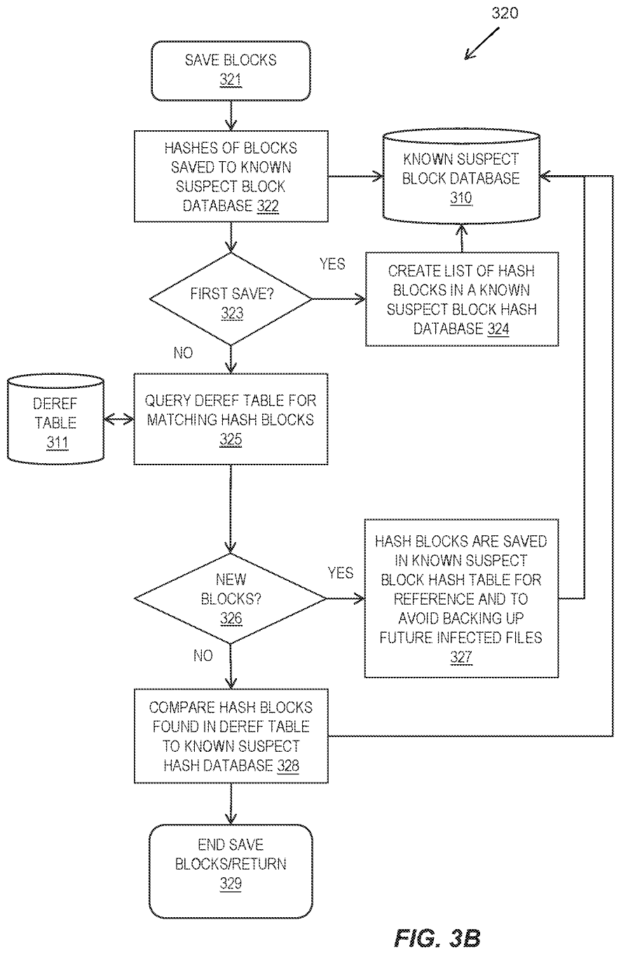

The infected files may be copied at operation 263 to a detection service, such as at a backend server, with a method to identify the file as “infected”. The identification may be a flag presented with a file passed from a backup command or a dedicated object store hosted on the backup server. The identified file is deduplicated at operation 264 as normal, using the existing deduplication algorithm in the environment. The method carries out 265 a call and return subprocess (e.g., as described in FIGS. 3A and 3B below) to save suspect signature blocks (e.g., hash blocks) to a searchable store. The searchable store may provide a malware hash block table and may optionally provide a dereference table for the blocks.

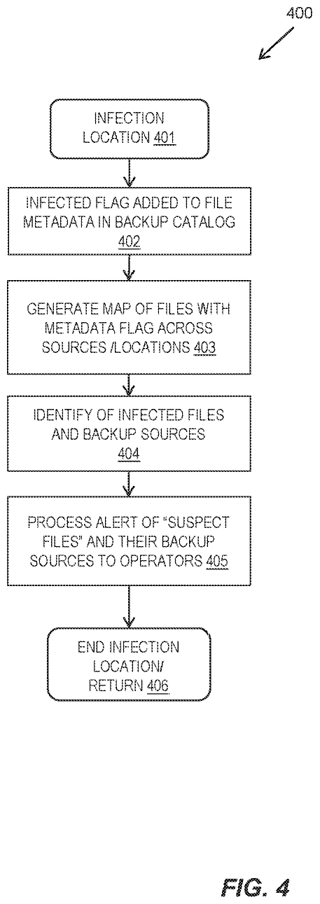

Once the known malware hash block table is populated, a subprocess to identify other clients using common blocks is either scheduled or actively run in near real-time. The method 250 may query at operation 266 deduplication pointer tables for files referencing the same hash blocks identified in the infected file from the hash block table. It is determined at operation 267 if there are matches and if so, the method calls an infection location subprocess as described below with reference to FIG. 4. See operation 270. However, if there are no matches, or after the infection location subprocess is called, the method ends the operations at 268, 271.

Referring now to FIG. 3A, a flow diagram of another method 300 shows a first approach of an aspect of the described process of building the suspect block database. One or more of the operations in method 300 may thereby be performed in order to protect multi-platform backup and NAS environments from malicious attacks. Accordingly, the method 300 may be performed in accordance with any of the approaches included herein, in various approaches. Of course, more or less operations than those specifically described in FIG. 3A may be included in method 300, as would be understood by one of skill in the art upon reading the present descriptions.

A save blocks subprocess may start at operation 301 when a deduplicated file is available for a suspect file. Details of the signature blocks which represent the file are stored in a searchable format. In one approach, hashes of the blocks are saved at operation 302 to “known suspect block database” 310. However, the searchable format may be in one of multiple different formats. Other approaches may store the suspect signature blocks in a text file or spreadsheet.

It is determined at operation 303 if this is a first save of the block. If so, the method creates at operation 304 a list of hash blocks in the known suspect block database at operation 310. In response to determining that the hash block is not a first save, the hashes that represent the blocks of the previously backed up version of the file are obtained at operation 305 from the backup server's database and compared to the presented version to determine at operation 306 if there are new blocks. New blocks may include data that has not been deduplicated before and therefore does not exist in the existing tables. If so, hash blocks are saved in the known suspect block database at operation 310 and in the deref table at operation 311 for reference and to avoid backing up future infected files at operation 307. If no new blocks are found in operation 306, the method may end at operation 309 the save blocks subprocess and return.

Referring now to FIG. 3B, a flow diagram of method 320 shows a second approach of an aspect of the described method of building the known suspect block database at operation 310 and deref table at operation 311. One or more of the operations in method 320 may thereby be performed in order to protect multi-platform backup and NAS environments from malicious attacks. Accordingly, the method 320 may be performed in accordance with any of the approaches included herein, in various approaches. Of course, more or less operations than those specifically described in FIG. 3B may be included in method 320, as would be understood by one of skill in the art upon reading the present descriptions.

A save blocks subprocess may start at operation 321 when a deduplicated file is available for a suspect file. Details of the signature blocks which represent the file are stored in a searchable format. In one approach, hashes of the blocks are saved at operation 322 to “known suspect block database” 310. However, the searchable format may be in one of multiple different formats.

A determination is made at operation 323 as to whether this is a first save of the block. If so, the method creates at operation 324 a list of hash blocks in the known suspect block database at operation 310. However, if the hash block is not a first save, the hashes that represent the blocks of the previously backed up version of the file are obtained at operation 325 from the backup server's database and compared to the presented version. This allows for dereferenced hashes to be stored in a deref table at operation 311, e.g., as would be appreciated by one skilled in the art after reading the present description. It is then determined at operation 326 if there are new blocks.

New blocks may include data that has not been deduplicated before and therefore does not exist in the existing tables. If so, hash blocks are saved in the known suspect block database at operation 310 and in the list for reference and to avoid backing up future infected files at operation 327. If no new blocks are found in operation 326 (i.e., determine at operation 326), the method may compare 328 the hash blocks found in the deref table at operation 311 to known suspect block database at operation 310. The method may end at operation 329 the save blocks subprocess and return.

Referring now to FIG. 4, a flow diagram of still another method 400 shows an aspect of the described process of the subprocess of infection location identifying. One or more of the operations in method 400 may thereby be performed in order to protect multi-platform backup and NAS environments from malicious attacks. Accordingly, the method 400 may be performed in accordance with any of the approaches included herein, in various approaches. Of course, more or less operations than those specifically described in FIG. 4 may be included in method 400, as would be understood by one of skill in the art upon reading the present descriptions.

Once the known malware hash table and optionally the deref table are populated, a subprocess to identify other clients using common blocks is either scheduled or run in near real-time. This process is identified as the “infection location subprocess” as used herein. The infection location subprocess may have different methods for static and for morphing code that may carry out at least some of the following operations.

The infection location subprocess may start at operation 401 with an infected flag being added at operation 402 to file metadata in a backup catalog. At 403, the method may generate a map of files with metadata flags across sources and locations. The method may identify 404 infected files and backup sources and may process at operation 405 an alert of the suspect files and their backup sources to operators. The infection location subprocess may then end at operation 406 and return as shown.

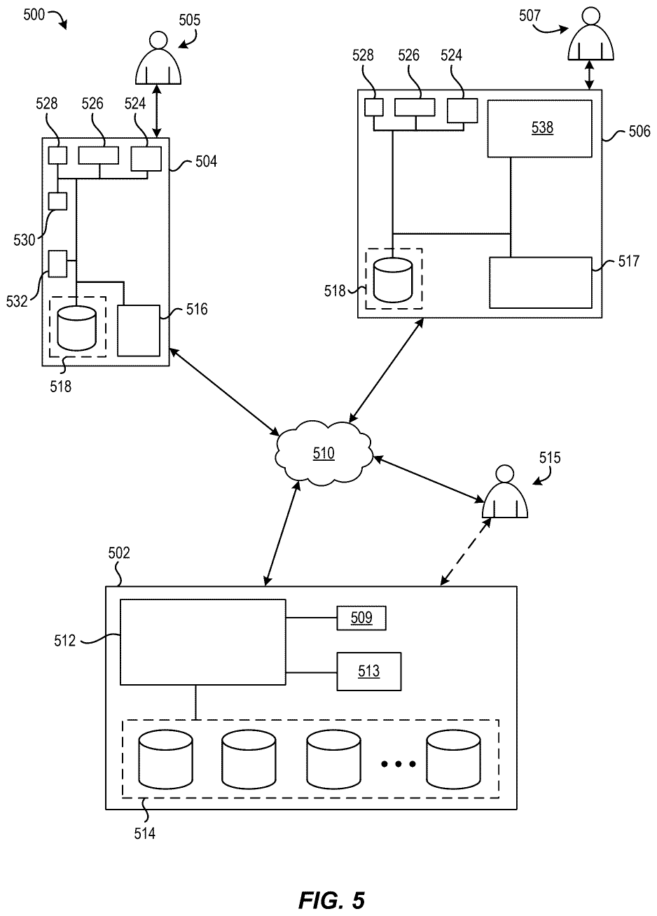

Looking now to FIG. 5, a distributed data storage system 500 in accordance with one approach. As an option, the present system 500 may be implemented in conjunction with features from any other approach listed herein, such as those described with reference to the other FIGS. However, this distributed data storage system 500 and others presented herein may be used in various applications and/or in permutations which may or may not be specifically described in the illustrative approaches or implementations listed herein. Further, the system 500 presented herein may be used in any desired environment. Thus FIG. 5 (and the other FIGS.) may be deemed to include any possible permutation.

As shown, the distributed data storage system 500 includes a central server 502 that is connected to user device 504 and edge node 506. Specifically, the central server 502, user device 504, and edge node 506 are connected to a network 510 that allows for data (e.g., information, commands, requests, instructions, responses, encrypted data, etc.) to be sent between any of the locations 502, 504, 506.

The network 510 may be of any type, e.g., depending on the desired approach. For instance, in some approaches the network 510 is a WAN, e.g., such as the Internet. However, an illustrative list of other network types which network 510 may implement includes, but is not limited to, a LAN, a PSTN, a SAN, an internal telephone network, etc. As a result, any desired information, data, commands, instructions, responses, requests, etc. may be sent between the locations 502, 504, 506, regardless of the amount of separation which exists therebetween, e.g., despite being positioned at different geographical locations. It should also be noted that the different locations 502, 504, 506 may be connected to each other (and/or other locations) differently depending on the approach. According to an example, two host locations may be located relatively close to each other and connected by a wired connection, e.g., a cable, a fiber-optic link, a wire, etc. ; etc., or any other type of connection which would be apparent to one skilled in the art after reading the present description.

With continued reference to FIG. 5, the central server 502 includes a large (e.g., robust) processor 512 coupled to a cache 509, AI module 513, and primary storage 514 having a relatively high storage capacity. The central server 502 is thereby able to process and store a relatively large amount of data blocks, allowing it to be connected to, and manage, multiple different remote locations.

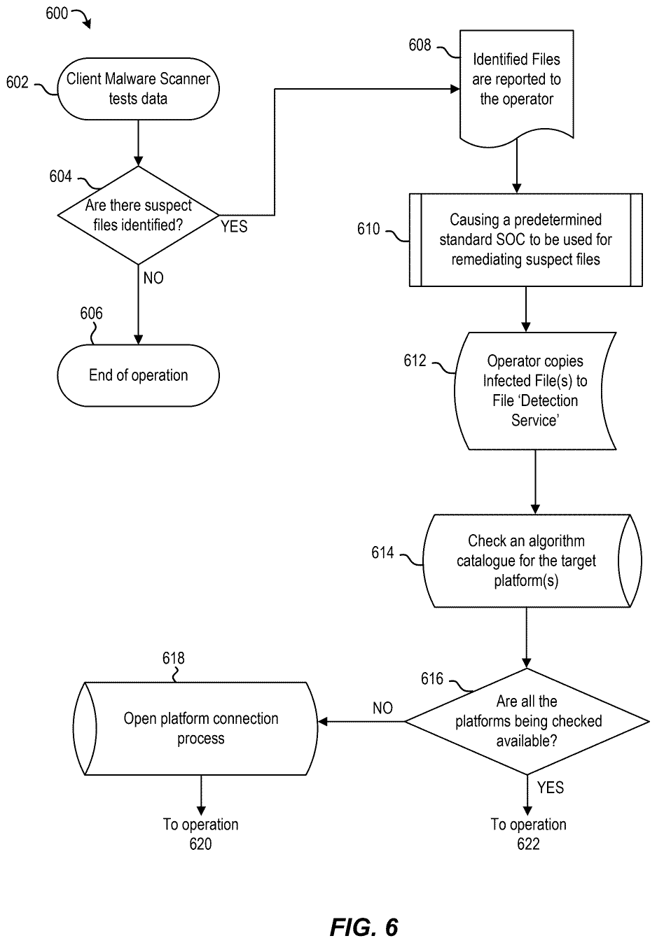

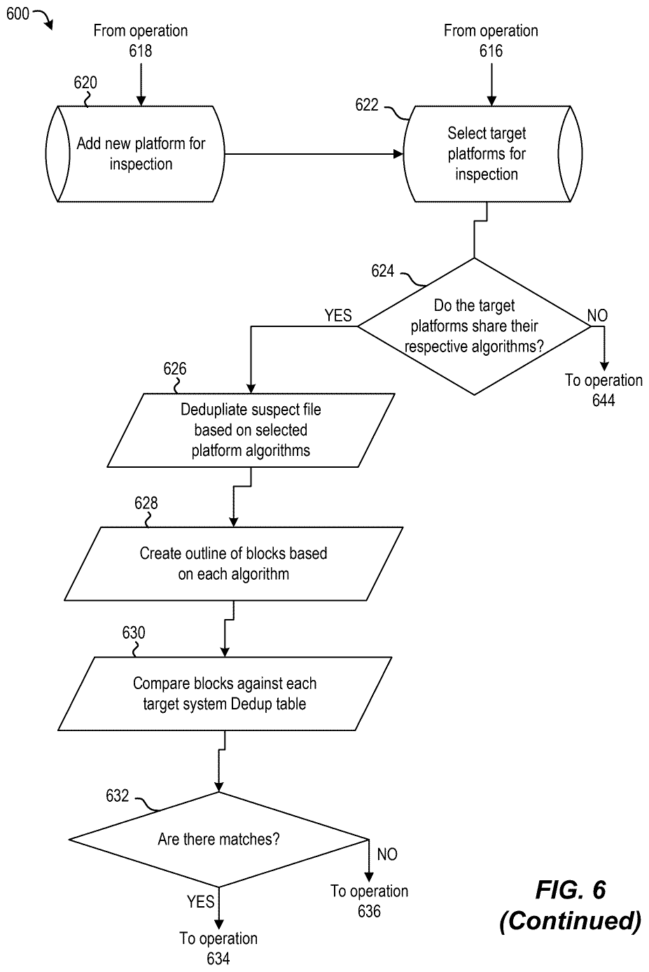

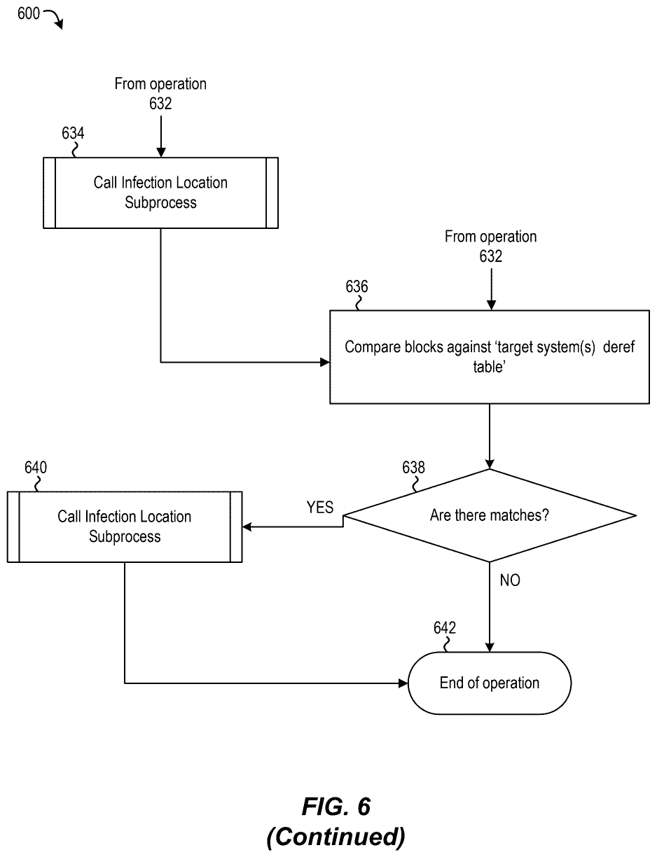

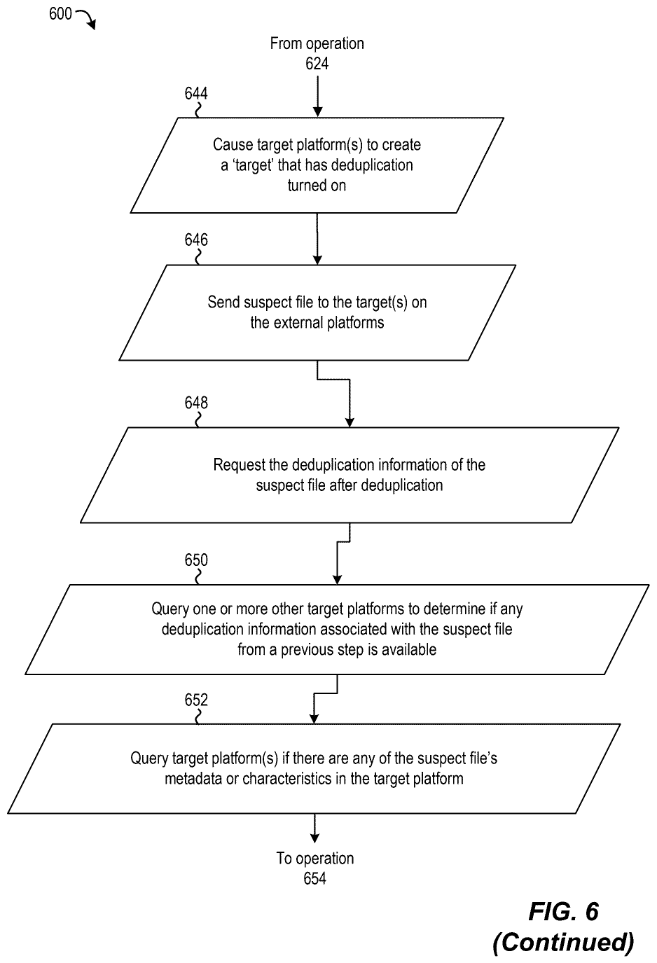

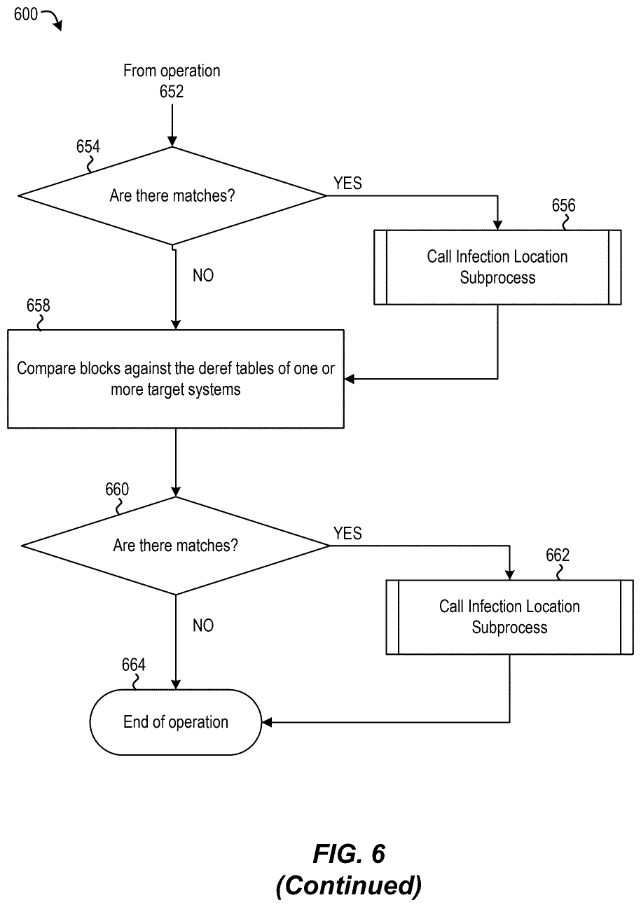

The AI module 513 may include any desired number and/or type of AI-based models, e.g., such as machine learning models, deep learning models, neural networks, etc. Moreover, one or more of the models that are included in the AI module 513 may be configured to interact with the processor 512 and applications running therein. For example, the AI module 513 may monitor information (e.g., data, applications, microservices, etc.) that is present in the central server 502 and determine whether any nefarious actors are present. For instance, the AI module 513 may be trained to evaluate information in the central server 502 and determine whether any identified patterns match those produced by malware. It follows that in preferred approaches, the AI module 513 includes AI based models that are trained to evaluate and classify system performance based at least in part on whether the actions taken and/or resulting biproducts match those of malware. The AI based models may further be incrementally re-trained as malware is removed and/or identified as a false positive. This insight as to how the AI based models perform may be received and evaluated over time, thereby providing accurate insight into how the system operates at any given point in time. Again, this allows approaches herein to accurately identify malware and/or other types of malicious code, even when dormant which has not been conventionally achievable. AI module 513 and/or processor 512 may thereby be used to perform one or more of the operations in method 600 of FIG. 6, e.g., as will be described in further detail below.

Still looking to FIG. 5, user device 504 may be a mobile phone that includes a processor 516 coupled to memory 518 that is accessible to a user 505. The processor 516 may receive inputs from, and interface with, user 515. For instance, the user 515 may input information using one or more of: a display screen 524, keys of a computer keyboard 526, a computer mouse 528, a microphone 530, and a camera 532. The processor 516 may thereby be configured to receive inputs (e.g., text, sounds, images, motion data, etc.) from any of these components as entered by the user 515. These inputs typically correspond to information presented on the display screen 524 while the entries were received. Moreover, the inputs received from the keyboard 526 and computer mouse 528 may impact the information shown on display screen 524, data stored in memory 518, information collected from the microphone 530 and/or camera 532, status of an operating system being implemented by processor 516, etc.

Moreover, edge node 506 includes some of the same or similar components as those included in other locations of system 500, and have therefore been given corresponding numbering. For instance, controller 517 is coupled to memory 518, a display screen 524, keys of a computer keyboard 526, and a computer mouse 528, which are accessible to administrator 507, e.g., at a built-in computer terminal for the edge node 506. Additionally, the controller 517 is coupled to an AI module 538 which may be configured to train, manage, and/or apply any one or more of the trained AI based models described above with respect to AI module 513, e.g., as would be appreciated by one skilled in the art after reading the present description.

As noted above, approaches herein are desirably able to detect malware activity in systems in an efficient manner, even when it is dormant. This desirably provides a way-especially for clients with multiple different deduplication techniques which may correspond to different vendors-to search for malware using deduplication (e.g., hash tables). Moreover, by normalizing them across platforms, approaches herein are able to even further improve system security.

Looking now to FIG. 6, a flowchart of a computer-implemented method 600 for rapid and mass detection of malware from various systems is illustrated in accordance with one approach. One or more of the operations in method 600 may thereby be performed in order to protect multi-platform backup and NAS environments from malicious attacks. Accordingly, the method 600 may be performed in accordance with any of the approaches included herein in FIGS. 1-5, among others, in various approaches. Of course, more or less operations than those specifically described in FIG. 9 may be included in method 600, as would be understood by one of skill in the art upon reading the present descriptions.

Each of the operations of the method 600 may be performed by any suitable component of the operating environment. For example, in various approaches, the method 600 may be partially or entirely performed by a controller, a processor, a computer, etc., or some other device having one or more processors therein. Thus, in some approaches, method 600 may be a computer-implemented method. Moreover, the terms computer, processor and controller may be used interchangeably with regards to any of the approaches herein, such components being considered equivalents in the many various permutations of the present invention.

Accordingly, in some approaches at least some of the operations of method 600 may be performed by an AI model that is trained using a predetermined training set of data and/or performance data experienced over time. For example, in some approaches, various of the operations noted above may be deployed in a trained state of a trained AI model. Training of the AI model, in some approaches, may be performed by applying a predetermined training data set to learn how to identify and/or recover from malware injected into a system. Predetermined training data sets may also be applied to learn how to protect volumes in a primary storage from data loss resulting from other nefarious events (e.g., denial-of-service (DoS), phishing, etc. attacks) as well as maintain information that improves the efficiency by which future events may be overcome. Initial training may include reward feedback that may, in some approaches, be implemented using a subject matter expert (SME) that generally understands how to identify and/or recover from cybersecurity attacks. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing at least some of the techniques and/or operations of method 600 may be performed. In some further approaches, the AI model may be a neuromyotonic AI model that may improve performance of computer devices in an infrastructure associated with protecting a system against malware and/or other types of nefarious attacks, because the neuromyotonic AI model may not need an SME and/or iteratively applied training with reward feedback in order to accurately perform operations described herein. Instead, the neuromyotonic AI model is configured to itself make determinations described in operations herein.

Weight values may, in some approaches, be used by the AI reasoning model to collect information and/or feedback potentially received from data storage environment, and analyze the information to determine the current status of the system. Such an AI model ensures that even dormant malware is identified and removed from systems. The AI model(s) may also ensure that runnable exploit scripts that incorporate system recovery are automatically generated and tested, where the scale of such analysis and determinations would not otherwise be feasible for a human to perform. This is because humans are not able to efficiently do so, and would otherwise incorporate processing delays and errors in the process of performing the approaches included herein. Accordingly, management of operations described herein is not able to be achieved by human manual actions.

Moreover, for those approaches having a processor, the processor, e.g., processing circuit(s), chip(s), and/or module(s) implemented in hardware and/or software, and preferably having at least one hardware component may be utilized in any device to perform one or more operations of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, operation 602 includes initiating a client malware scanner (e.g., as described herein) and using the scanner to test data in systems. In other words, the malware scanner examines the information that is present in a system in an attempt to identify any malware. In preferred approaches, operation 602 includes causing one or more AI based models to monitor and/or evaluate portions of the system. These AI based models may be trained to identify patterns in the data being scanned which indicate that the system has malware (even dormant malware) therein.

From operation 602, method 600 advances to operation 604. There, operation 604 includes determining whether any suspect files have been identified. In other words, operation 604 involves determining whether any malware (or other malicious activity and/or code) has been identified in the system as a result of the scanning. In response to determining that suspect files have not been identified, method 600 advances to operation 606 which includes causing the operation to end. In other words, method 600 may end in response to reaching operation 606.

However, method 600 advances from operation 604 to operation 608 in response to determining that one or more suspect files have been identified. The term “suspect file(s)” refers to a portion of information in the system that have been identified as potentially being malware and/or other malicious material. There, operation 608 includes reporting the identified suspect files to an operator. In other words, operation 608 includes providing a notification that outlines information about the suspect files that have been identified. This notification may be sent over a network, physical communication line, etc., and/or combinations thereof.

From operation 608, method 600 advances to step 610. There, step 610 includes causing a predetermined standard SOC to be used for remediating suspect files. It should be noted that step 610 may involve sending instructions, commands, requests, etc., to a location of the data being examined, which ultimately cause step 610 to be performed there and not locally with remaining operations in method 600. In some approaches, step 610 includes applying a predetermined standard SOC for remediating the suspect files. In response to step 610 being completed, method 600 advances to operation 612. There, operation 612 includes causing the suspect files to be copied to a file detection service. It follows that 610 and/or 612 involves identifying a suspect file and copying the suspect file to a detection service. As noted above, a detection service is preferably configured to identify the file as “infected”. The identification may be a flag presented with a file passed from a backup command or a dedicated object store hosted on the backup server. In some approaches, operation 612 includes deduplicating the identified file as normal, using any desired deduplication algorithm in the environment.

Furthermore, operation 614 includes checking an algorithm catalog for one or more target platforms, before proceeding to operation 616. Depending on the approach, the target platforms that may be identified from the algorithm catalog may include NAS devices that have deduplication, other backup systems that leverage deduplication from multiple vendors, WAN Accelerators using deduplication or any other type of data storage device, etc. and/or combinations thereof.

In response to examining the algorithm catalog and identifying one or more target platforms in the algorithm catalog, operation 616 determines whether the identified target platforms are available. In response to determining that one or more of the identified target platforms are not available, method 600 advances to operation 618. There, operation 618 includes opening a platform connection process. In other words, operation 618 includes running (e.g., initiating) a platform connection process that is preferably configured to introduce new target platforms for inspection. Accordingly, operation 620 includes adding new target platforms for inspection. The number of target platforms that are added in operation 620 preferably matches the number of target platforms identified in operation 616 as being unavailable.

Method 600 advances from operation 620 to operation 622. Additionally, method 600 advances from operation 616 directly to operation 622 in response to determining that all of the target platforms are available. There, operation 622 includes selecting the target platforms for inspection. In other words, in response to identified target platforms being identified as currently available and/or newly added in response to one or more of the platforms being unavailable, these target platforms are chosen for further evaluation, e.g., as will soon become apparent. Here, “selecting” the target platforms for further evaluation may include taking the platforms offline, creating copies of the respective platforms, changing formatting of the platforms, etc., and/or combinations thereof.

Proceeding to operation 624, there method 600 includes determining whether each of the target platforms shares their respective algorithms. In other words, operation 624 includes determining whether the algorithms that correspond to each of the identified and available target platforms may be applied in different situations and effectively used as desired. According to one embodiment, vendors of the target platforms might opt to share (e.g., make public, share under a non-disclosure agreement) deduplication algorithms. For instance, the algorithms may be made public or usable by an implementer and could then be internalized and used inside a system in comparison to only being consumed externally. In some approaches, operation 624 determines this based at least in part on lookup tables, past performance, outputs generated by AI based models, etc., and/or combinations thereof.

In response to determining that one or more of the target platforms do not share their respective algorithms, method 600 advances from operation 624 to operation 644, e.g., as will be described in further detail below. However, in response to determining that the target platforms share their respective algorithms, method 600 advances from operation 624 to operation 626. There, operation 626 includes deduplicating the suspect file. In preferred approaches, the deduplication is based at least in part on the algorithms that correspond to the selected target platforms from the algorithm catalog. In other words, the system is able to deduplicate the suspect or “bad” file using those different deduplication algorithms and get an outline of what the blocks would look like after the deduplication is performed. This would in turn produce a set of blocks that could be compared against the target system tables to identify if the suspect file exists in the storage. Removing duplicate algorithms and/or target platforms improves performance by reducing latency that may otherwise be experienced as a result of evaluating the same algorithm and/or target platform multiple times to arrive at the same result. Performing operation 626 may include applying any one or more deduplication algorithms, e.g., which may correspond to different types of data, users, industry standards, performance metrics, etc., and/or combinations thereof.

From operation 626, method 600 advances to operation 628. There, operation 628 includes creating an outline of blocks. The blocks that are included in the outline include those blocks that a suspect or bad file would represent after being deduplicated by any specific deduplication algorithm. Each deduplication algorithm would break the blocks down into different representations in their respective pointer or hash tables. In other words, operation 628 includes creating an outline of blocks based on the respective algorithms that correspond to the selected target platforms.

Method 600 advances from operation 628 to operation 630. There, operation 630 includes comparing the blocks against each target system deduplication table. In other words, the blocks are compared against each target system deduplication table. Each of the blocks that are included in the outline created in operation 628 may thereby be compared against different respective deduplication tables. The operations described above may thereby effectively break a file into a number of different blocks, and place them in a deref table. The blocks that would be used and compared against the existing ones in the deref table of the target system may thereby be used to see if the target system contains blocks that exist already and which match, thereby representing existing files in the target storage system.

From operation 630, method 600 advances to operation 632 which determines whether there are any matches between the blocks and their respective deduplication tables. The determination made in operation 632 may thereby be based at least in part on the comparisons performed in operation 630. Moreover, in response to determining that one or more of the blocks are matching (matches do exist between the different blocks), method 600 advances to operation 634. There, operation 634 includes calling an infection location subprocess. In other words, operation 634 includes initiating and running an infection location subprocess. As noted above, the infection location subprocess may be a subprocess that is configured to identify other clients using common blocks is either scheduled or run in near real-time. The infection location subprocess may have different methods for static and for morphing code that may carry out at least some of the operations described herein.

Method 600 advances from operation 634 to operation 636. Method 600 also advances from operation 632 to operation 636 in response to determining that none of the blocks are matching. In other words, method 600 advances directly from operation 632 to operation 636 in response to determining that none of the blocks formed in operation 630 are overlapping. There, operation 636 includes comparing the blocks against a target system deref table. As noted above, dereference resources store information about blocks which are no longer involved to construct the current version of a file. For instance, blocks that are no longer needed to represent the malware infected version of a file will have their respective hash values stored in a deref table as these are the hashes that may indicate the presence of malware in other files or systems. Alternatively, the known suspect block hash table may include an index of previous versions that can be searched against. In other approaches, the method may be used without the dereference resource to identify malware. This may be used to identify possible locations of suspicious blocks of data without the further test for morphing code. Other additional tests may be carried out on the identified suspicious blocks.

Operation 638 further includes determining whether there are any matches identified as a result of comparing the blocks against the target system deref table. In some approaches, the blocks may be compared against more than one different deref tables. In response to determining that there are one or more matches between the blocks and the target system deref table, method 600 advances from operation 638 to operation 640. There, operation 640 includes calling an infection location subprocess. It follows that performing operation 640 may include any of the approaches above described with respect to operation 634 above.

From operation 640, method 600 advances to operation 642 which includes causing the operation to end. In other words, method 600 ends in response to reaching operation 642. Similarly, method 600 advances directly from operation 638 to operation 642 in response to determining that there are no matches between the blocks and the target system deref table.

Returning now to operation 624, method 600 advances to operation 644 in response to determining that one or more of the target platforms do not share their respective algorithms. There, operation 644 includes causing the target platforms to create one or more ‘targets’ that have deduplication enabled. In other words, operation 644 includes sending one or more instructions, commands, etc., that ultimately cause (e.g., result in) each of the identified target platforms to form a respective share, bucket, etc., that serves as a target, and which is also configured to perform deduplication. Again, deduplication is desirable because it improves system performance by reducing latency and increasing storage capacity.

From operation 644, method 600 proceeds to operation 646. There, the suspect file is sent to the targets on the external platforms. One or more instructions may also be sent along with the suspect file, the instructions causing the respective targets on the external platforms to perform deduplication. Accordingly, operation 648 includes requesting deduplication information of the suspect file in response to the deduplication being performed. Operation 648 may request deduplication information that includes (but is in no way limited to) blocks, telemetry data, characteristics, etc., and/or combinations thereof.

In response to receiving the deduplication information, method 600 advances to operation 650. There, operation 650 includes querying one or more other target platforms to determine if any deduplication information associated with the suspect file from a previous step is available. In other words, operation 650 includes determining if any deduplication information corresponding to the suspect file (e.g., requested in the previous step) is available by querying the target platform. This may be done by inspecting any other available target platforms to verify whether any blocks or other data characteristics which were correlated with the suspect file in the past. For example, blocks and/or other data characteristics may be generated for the suspect file during a previous iteration of performing the operations in method 600 and subsequently stored in memory. Depending on the approach, the memory may include any type of storage components that maintain the deduplication tables, deref information pools, hash tables, etc., and/or combinations thereof. In response to identifying blocks or other data characteristics associated with the suspect file in the other target platforms, a request may be sent to the target platforms for the identified blocks or other data characteristics.

From operation 650, method 600 advances to operation 652. There, operation 652 includes querying the one or more other target platforms and determining if any metadata and/or characteristics associated with the suspect file are available. In other words, operation 652 includes determining if any metadata and/or characteristics corresponding to the suspect file (requested in the previous step) is available by querying the target platform. For example, operation 652 may include querying the other target platforms for name(s), a size, formatting, etc. and/or combinations thereof of the suspect file. This information provides additional context that provides insight as to whether the suspect file actually does include metadata that should be addressed. In response to identifying metadata and/or characteristics associated with the suspect file in the other target platforms, a request may be sent to the target platforms for the identified metadata and/or characteristics.

Method further proceeds to operation 654 which includes determining whether any matches exist. In other words, operation 654 determines whether any blocks, metadata, and/or characteristics associated with the suspect file were identified. In response to determining there are matches of the blocks in the tables, this indicates that if the suspect file, when deduplicated, creates blocks that would match existing blocks in the target system, this indicates that a similar or the same suspect file exists in that storage system, e.g., depending on the number of identified matching blocks. In response to determining that at least some of this suspect file information is available in the other target platforms queried in operations 650 and/or 652, method 600 advances to operation 656. There, operation 656 includes calling an infection location subprocess. It follows that performing operation 656 may include any of the approaches above described with respect to operation(s) 640 and/or 634 above.

From operation 656, method 600 advances to operation 658. There, operation 658 includes comparing blocks against the deref tables of one or more target systems. In other words, operation 658 includes comparing the blocks against a target system deref table, e.g., as would be appreciated by one skilled in the art after reading the present description.

Proceeding now to operation 660, method 600 determines whether any matches exist. In other words, operation 660 determines whether any of the blocks match one or more entries in the deref tables. In response to determining that one or more matches do exist between the blocks and the deref table entries, method 600 advances to operation 662. There, operation 660 includes calling an infection location subprocess. It follows that performing operation 660 may include any of the approaches described above with respect to operation(s) 656 and/or 640 and/or 634 above.

From operation 662, method 600 advances to operation 664 which includes causing the operation to end. In other words, method 600 may end in response to reaching operation 664. Method 600 also advances from operation 660 directly to operation 664 in response to determining that no matches exist between the blocks and the deref table entries.

Again, approaches herein are desirably able to create a cross platform process of performing malware discovery in systems that may not be scanned regularly, e.g., by Endpoint Detection and Response (EDR) tooling. Approaches herein also create options to integrate searching across dispart vendors and deduplication technology across various platforms. This desirably provides a way to help clients improve system performance by implementing extensions. Again, this is achieved by being able to search for malware in data at rest, at archive, and/or in filesystems without having to walk the filesystem NAS mount or scan other sources. This allows for malware to be easily searched across multiple platforms and multiple vendors without embedding the search technology into each unique system. This allows for the ability to nominalize search across multiple vendors and find malware that may exist in multiple repositories at the same time, even when that malware is dormant which has been conventionally unachievable.

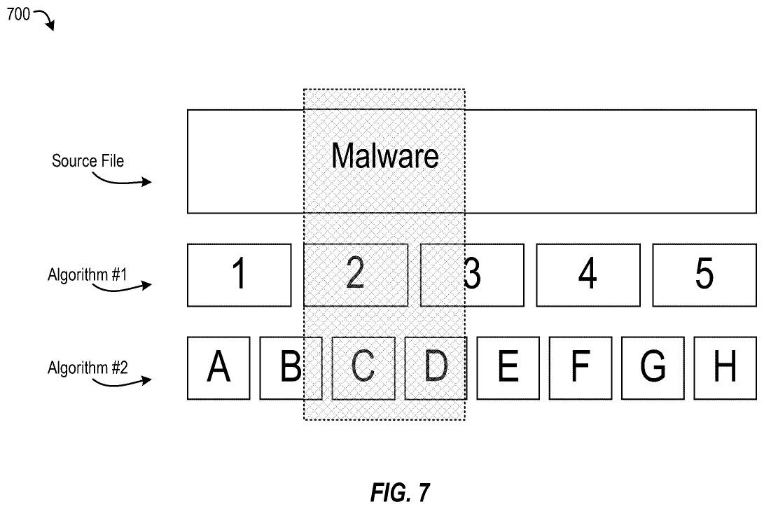

For approaches having more than one system that implement more than one system where more than one deduplication algorithm is used, different block lengths may be used. For instance, approaches having two different systems have different algorithms, and the algorithms choose different block lengths. As a result, different numbers of blocks are used to represent each of the different files, data structures or other types of stored data to be deduplicated such as but not limited to BLOBs (Binary Large Objects), structured data files or data streams, etc. According to a non-limiting example, FIG. 7 shows an overview 700 of how malware in a source file overlays different block sizes. As shown, Algorithm 1 produces block/hash pairs referenced 1, 2, 3, 4, 5, while Algorithm 2 produces blocks/hash pairs referenced A, B, C, D, E, F, G, H. However, it should be noted that for ease of understanding, the diagram shows malware existing in a single contiguous section of the deduplicated data. However, it may be the case in other approaches that malware is in multiple non-contiguous sections of the deduplicated data. For additional clarity, the blocks representing the data for each algorithm are shown as being the same size, while some deduplication algorithms are fixed block size, many algorithms use a variable block size. Moreover, communication of the problem block/hash pairs between the systems may be performed in this example using a pre-defined protocol, e.g., such as but not limited to an API, REST, machine to machine messaging protocols (e.g., MQTT), file and metadata transfer protocols, etc., and/or combinations thereof.

Referring still to FIG. 7, malware is present in blocks 2 & 3 of Algorithm 1 as well as blocks B, C, D of Algorithm 2. To detect the malware in this scenario, the implementation is normalized between the two algorithms. This may typically be achieved by the system with Algorithm 2 sending data to the system running the detection (blocks and corresponding hashes) which allows the system running the detection to compare with its blocks/hashes and report back that the system running Algorithm 2 that the system needs to inspect blocks B, C and D. It should be noted that in this example the algorithms need not be shared, only the data/metadata output by the respective algorithms is exchanged, thereby maintaining data integrity and secrecy.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
identifying a suspect file and copying the suspect file to a detection service;
checking an algorithm catalog for one or more target platforms;
in response to identifying one or more target platforms in the algorithm catalog, selecting the target platforms for inspection; and
in response to determining that the target platforms share their respective algorithms:
deduplicating the suspect file based at least in part on the algorithms that correspond to the selected target platforms,
creating an outline of blocks based on the respective algorithms that correspond to the selected target platforms,
comparing the blocks against each target system deduplication table, and
in response to determining that none of the blocks are matching, comparing the blocks against a target system deref table.

2. The method of claim 1, further comprising:
in response to determining that one or more of the blocks are matching, calling an infection location subprocess.

3. The method of claim 1, further comprising:
in response to determining that there are one or more matches between the blocks and the target system deref table, calling an infection location subprocess.

4. The method of claim 3, further comprising:
in response to determining that there are no matches between the blocks and the target system deref table, causing the operation to end.

5. The method of claim 1, further comprising:
in response to determining that the target platforms do not share their respective algorithms:
causing a target platform to create a target that has deduplication enabled;
requesting deduplication information of the suspect file in response to deduplication being performed;
determining if any deduplication information corresponding to the suspect file is available by querying the target platform;
determining if any metadata and/or characteristics corresponding to the suspect file is available by querying the target platform; and
in response to determining that none of the blocks are matching, comparing the blocks against a target system deref table.

6. The method of claim 5, further comprising:
in response to determining that one or more of the blocks are matching, calling an infection location subprocess.

7. The method of claim 6, further comprising:
in response to determining that there are one or more matches between the blocks and the target system deref table, calling an infection location subprocess.

8. The method of claim 7, further comprising:
in response to determining that there are no matches between the blocks and the target system deref table, causing the operation to end.

9. A computer program product comprising:
one or more computer-readable storage media; and
program instructions stored on the one or more storage media to perform operations comprising:
identifying a suspect file and copying the suspect file to a detection service;
checking an algorithm catalog for one or more target platforms;
in response to identifying one or more target platforms in the algorithm catalog, selecting the target platforms for inspection; and
in response to determining that the target platforms share their respective algorithms:
deduplicating the suspect file based at least in part on the algorithms that correspond to the selected target platforms,
creating an outline of blocks based on the respective algorithms that correspond to the selected target platforms,
comparing the blocks against each target system deduplication table, and
in response to determining that none of the blocks are matching, comparing the blocks against a target system deref table.

10. The computer program product of claim 9, wherein the operations further comprise:
in response to determining that one or more of the blocks are matching, calling an infection location subprocess.

11. The computer program product of claim 9, wherein the operations further comprise:
in response to determining that there are one or more matches between the blocks and the target system deref table, calling an infection location subprocess.

12. The computer program product of claim 11, wherein the operations further comprise:
in response to determining that there are no matches between the blocks and the target system deref table, causing the operation to end.

13. The computer program product of claim 9, wherein the operations further comprise:
in response to determining that the target platforms do not share their respective algorithms:
causing a target platform to create a target that has deduplication enabled;
requesting deduplication information of the suspect file in response to deduplication being performed;
determining if any deduplication information corresponding to the suspect file is available by querying the target platform;
determining if any metadata and/or characteristics corresponding to the suspect file is available by querying the target platform; and
in response to determining that none of the blocks are matching, comparing the blocks against a target system deref table.

14. The computer program product of claim 13, wherein the operations further comprise:
in response to determining that one or more of the blocks are matching, calling an infection location subprocess.

15. The computer program product of claim 14, wherein the operations further comprise:
in response to determining that there are one or more matches between the blocks and the target system deref table, calling an infection location subprocess.

16. The computer program product of claim 15, wherein the operations further comprise:
in response to determining that there are no matches between the blocks and the target system deref table, causing the operation to end.

17. A computer system comprising:
a processor set;
one or more computer-readable storage media; and
program instructions stored on the one or more storage media to cause the processor set to perform operations comprising:
identifying a suspect file and copying the suspect file to a detection service;
checking an algorithm catalog for one or more target platforms;
in response to identifying one or more target platforms in the algorithm catalog, selecting the target platforms for inspection; and
in response to determining that the target platforms share their respective algorithms:
deduplicating the suspect file based at least in part on the algorithms that correspond to the selected target platforms,
creating an outline of blocks based on the respective algorithms that correspond to the selected target platforms,
comparing the blocks against each target system deduplication table, and
in response to determining that none of the blocks are matching, comparing the blocks against a target system deref table.

18. The computer system of claim 17, wherein the operations further comprise:
in response to determining that the target platforms do not share their respective algorithms:
causing a target platform to create a target that has deduplication enabled;
requesting deduplication information of the suspect file in response to deduplication being performed;
determining if any deduplication information corresponding to the suspect file is available by querying the target platform;
determining if any metadata and/or characteristics corresponding to the suspect file is available by querying the target platform; and
in response to determining that none of the blocks are matching, comparing the blocks against a target system deref table.

19. The computer system of claim 17, wherein the operations further comprise:
in response to determining that one or more of the blocks are matching, calling an infection location subprocess.

20. The computer system of claim 19, wherein the operations further comprise:
in response to determining that there are one or more matches between the blocks and the target system deref table, calling an infection location subprocess.
